(19) United States
(12) Patent Application Publication
(10) Pub. No.: US 2008/0069589 A1
(43) Pub. Date: Mar. 20, 2008

(54) FUSING DEVICE AND IMAGE FORMING APPARATUS HAVING THE SAME

(75) Inventors: Woong-jae CHANG, Seongnam-si (KR); Sea-chul Bae, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/736,194

(22) Filed: Apr. 17, 2007

(30) Foreign Application Priority Data
Sep. 15, 2006 (KR) 2006-89822

(51) Int. Cl. G03G 15/20

(52) U.S. Cl. 399/122

(57) ABSTRACT

A fusing device of an image forming apparatus which applies principles of leverage, and an image forming apparatus containing such a device. The fusing device includes a fusing unit having a heating roller and a pressure roller facing each other and which rotate together, a cover which opens and closes the fusing unit, and a pressure and release unit, one end of which is rotatably fixed to a rotating shaft, the pressure and release unit containing a member having a pressuring unit which pressures the pressure roller towards the heating roller when the cover opens and shuts, and a pressured part, which is farther from the rotating shaft than the pressuring part and which receives pressure from the cover.

### CROSS-REFERENCE TO RELATED APPLICATION

This application claims the priority of Korean Patent Application No. 2006-89822 filed on Sep. 15, 2006, in the Korean Intellectual Property Office, the disclosure of which is incorporated herein by reference.

### BACKGROUND OF THE INVENTION

1. Field of the Invention

Aspects of the present invention relate to a fusing device of an image forming apparatus, and more specifically, to a device which releases the pressure between rollers used in fusing an electrostatic latent image onto print material.

2. Description of the Related Art

Image forming apparatuses generally include a paper feed device which picks up paper from a feeding tray and feeds the paper along a feed path, a developing device which applies developing materials to an electrostatic latent image and develops the image, a transfer device which transfers the developed image onto the paper, and a fusing device which fuses the developed image onto a surface of the paper using heat and pressure.

FIG. 1 is a conceptual diagram explaining how a fixing roller in a related art fusing device is pressured and released. As shown in FIG. 1, a related art fusing device 1 includes a heating roller 2 which heats the paper, a pressure roller 3 which provides pressure when in contact with the heating roller 2, a pressure spring 4 which presses the rotational axis 3′ of the pressure roller 3 towards the heating roller 2 and maintains pressure on the pressure roller 3, and a pressure release member 6 disposed on the side of the rotational axis 3′ opposite the pressure spring 4 which releases pressure by pushing the rotational axis 3′ of the pressure roller 3 in the direction of the pressure spring 4 according to the rotation of a cam 5.

In such a configuration, the pressure supplied by the pressure roller 3 is maintained or released according to a rotation of the cam 5. That is, in order to release the pressure, the installed cam 5 rotates according to the method described above, and the pressure release member 6 releases the pressure by pushing the pressure roller 3 away from the heating roller 2 while rotating around a hinge 6′ towards the pressure spring 4. If the cam 5 rotates in the opposite direction, pressure is added to the pressure roller 3 using the pressure spring 4.

When the cover of the image forming apparatus is opened for purposes of maintenance or the like, for example, when paper is jammed between the heating roller 2 and the pressure roller 3 during image formation, or when the cover is closed in order to operate the image forming apparatus, the pressure roller 3 should be pressured or released, and so the opening and closing of the cover and the rotation of the cam should occur together.

In a related art fusing device, various mechanisms have been suggested in order to achieve this joint opening and closing. One suggested method uses a position detection sensor on the cam, and a power source which moves the cam so the position of the cam can be adjusted according to the opening and closing of the cover.

However, if a separate power source and position detection sensor are used as described above, these added components increase costs, and if the system suddenly halts during operation (for example, due to power being cut or a lightning strike), the reliability of the high pressure release function also drops, or additional costs are required to maintain reliability.

A second suggested method adjusts the angle of the cam according to whether the cover is open or shut by installing a lever attached to one side of the cover and connecting the other side of the cover to part of the cam. However, a problem with this second suggested method is that the reliability of the high pressure release function may drop if the configuration changes due to changes in the lever or cam caused by the high temperature of the heating roller or wear and tear of the cam parts.

An aspect of the present invention provides a fusing device in an image forming apparatus which resolves at least the above and/or other problems, reduces pressure in the fusing apparatus through the cover of the image forming apparatus being opened with minimal effort by the user, and increases pressure supplied by the pressure roller in a stable fashion when the cover is closed.

Another aspect of the present invention is to provide an image forming apparatus comprising the aforementioned fusing device.

### SUMMARY OF THE INVENTION

According to an aspect of the invention, a fusing device of an image forming apparatus designed in order to achieve the above and/or other aspects and advantages includes a fusing unit having a heating roller and a pressure roller which contact with other and rotate together, a cover which opens and closes the fusing unit, and a pressure and release unit, including a rotational shaft, and a member rotatable about the rotational shaft and having a pressuring part that transmits pressure to the pressure roller in a direction of the heating roller if the cover is shut and a pressured part pressured by the cover and disposed farther than the pressuring part from the rotational shaft.

According to an aspect, the cover includes a pressure boss to transmit the pressure to the pressured part.

According to an aspect, the pressure and release unit further includes a second rotational shaft, and a second member rotatable about the rotational shaft and having a second pressure boss pressured by the pressuring part, and a second pressuring part that is closer than the second pressure boss to the second rotational shaft and transmits pressure to the pressure roller.

According to an aspect, the second pressure boss is attached to the second pressuring part.

According to an aspect, a second spring inside of the second pressure boss should be stiffer than a spring inside of the first pressure boss.

According to an aspect, the second pressuring part is a side of a recess in which a rotational shaft of the pressure roller is rotatably inserted and which presses the pressure roller in a direction of the heating roller when the cover is closed.

According to an aspect, the second pressuring part includes a stopper to limit a rotation of the member to a predetermined internal range.

According to another aspect of the present invention, an image forming apparatus includes a document feed device which picks up a document from a feeding tray and feeds the document along a feed path, a developing device which applies developing materials to an electrostatic latent image to develop the electrostatic latent image, a transfer device which transfers the developing materials onto the document, and the pressure and release unit described above, which fuses the developing materials onto the document.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 conceptually shows the pressure and release of a fusing roller in a related art fusing apparatus;

FIG. 2 shows an embodiment of the fusing device according to an embodiment of the present invention;

FIG. 3 shows a state of the pressure roller shown in FIG. 2 in which the pressure has been released; and

FIG. 4 shows an image forming apparatus having the fusing device shown in FIG. 2.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

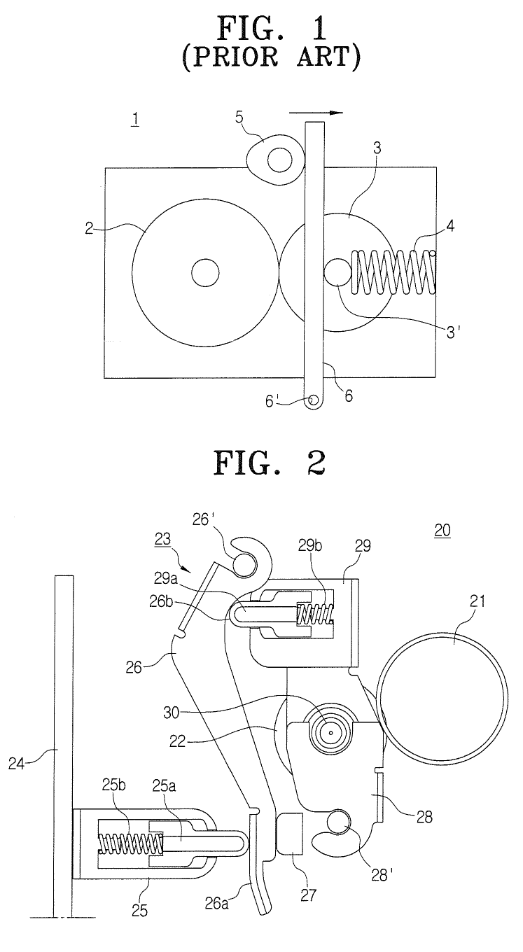

FIG. 2 shows an embodiment of the fusing device according to an embodiment of the present invention. The fusing device 20 of FIG. 2 includes a heating roller 21 which provides heat, and which a recording medium having a developed image passes by; a pressure roller 22, which faces the heating roller and provides pressure; and a pressure and release unit 23, also known as a lever unit, which provides pressure to and releases the pressure from the above pressure roller 21. It is understood that the recording medium may be various types of recording media, such as paper, transparency sheets, etc.

The pressure and release unit 23 is formed as a two-level lever. As is illustrated in FIG. 2, a first pressure boss 25 is disposed on the inside of a cover 24. A first sliding component 25a is supported by a spring 25b inside the first pressure boss 25. The first pressure boss 25 contacts and transmits pressure to the first pressured part 26a formed on the end of a first member 26, which rotates around a first rotating shaft 26′. It is understood that the first rotating shaft 26′ may instead be a hinge or any other component which rotates around a rotational axis.

The first member 26, also known as a first lever, includes a first pressuring part 26b disposed closer than the first pressured part 26a to the first rotating shaft 26′, and transmits the pressure received from the first pressured part 26a to the first pressuring part 26b, which is amplified according to the principle of leverage.

On the other side of the first pressured part 26a of the first member 26, a stopper 27 is installed so that when the cover 24 is closed, an area of movement of the first member 26 is restricted and the amount of pressure transmitted to the first pressured part 26a does not exceed a certain limit.

The second member 28, also known as a second lever, includes a second rotating shaft 28′, a second pressure boss 29 (also referred to as a second pressured part), and a channel 30 (also referred to as the second pressuring part) which transmits pressure to the pressure roller 22 through the rotating axis of the pressure roller 22, re-transmitting pressure which is again amplified by the principle of leverage. As shown in FIG. 2, the second pressuring part 30 is preferably a side of a recess in which a rotational shaft of the pressure roller 22 is rotatably inserted and which presses the pressure roller 22 towards the heating roller 21 when the cover 24 is closed. However, it is understood that the second pressuring part 30 is not limited to being a side of a recess, and instead may be various other components to engage a roller, such as a hollow protrusion. It is further understood that the second rotating shaft 28′ may instead be a hinge or any other component which rotates around a rotational axis.

As the second pressure boss 29, which is the second pressured part, receives the amplified power according to the construction described above, it is desirable that the strength, that is, the stiffness, of the spring 29b built into the second pressure boss 29 is greater than the strength of the spring 25b built into the first pressure boss 25. A second sliding component 29b is supported by the spring 29b. Moreover, since the springs 25b and 29b of the first and second pressure bosses 25 and 29, respectively, are able to conserve a fixed amount of energy, even if energy exceeding the minimum energy levels which the springs 25b and 29b need to press the pressure roller 22 into the heating roller 21 is transmitted to the pressure roller 22, pressure builds up in the springs 25b and 29b, and pressure can be released from the pressure roller 22 by opening the cover 24, or the cover 24 can be prevented from opening to maintain the energy levels.

The ratio between the length from the first rotational shaft 26′ to the first pressuring part 26b and the length from the first rotational shaft 26′ to the first pressured part 26a is preferably, but not necessarily, about 11:73.5. Moreover, the ratio between the length from the second rotational shaft 28′ to the second pressuring part 30 and the length from the second rotational shaft 28′ to the second pressured boss 29 which is the second pressured part is preferably, but not necessarily, about 23:55. Using these preferred ratios, in order to press the pressure roller with a force of, for example, 10 kgf, the size of the force to be applied to the cover decreases to 10*23/55*11/73.5=0.626 kgf=626 gf, so the force which should be applied to the cover is reduced by about 16 times. It is understood that other ratios may also be used to configure the structure of the fusing device.

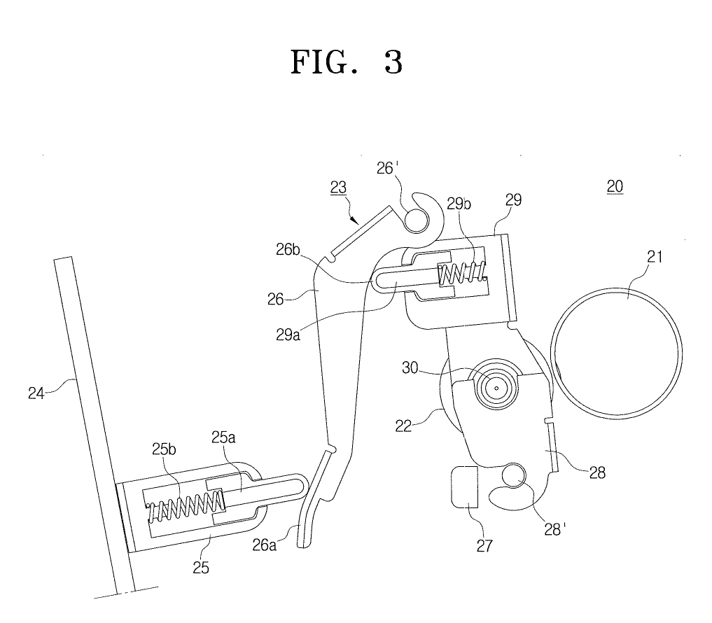

FIG. 3 illustrates an embodiment in which the pressure of the pressure roller 22 is released. Referring to FIG. 3, when the cover 24 is opened, the pressure of the first pressured part 26a is released. Specifically, when the cover 24 is opened, the first member 26 rotates around the first rotational shaft 26′ in the direction of the cover 24, so the first pressuring part 26b is released. When the first pressuring part 26b is released, while the pressure of the second pressure boss 29, which is the second pressured part, is released, the second member 28 rotates around the second revolving shaft in the direction of the cover 24 due to the elasticity of the heating roller 21 and the pressure roller 22. Thus, the pressure pressing the pressure roller 22 into contact with the heating roller 21 is removed.

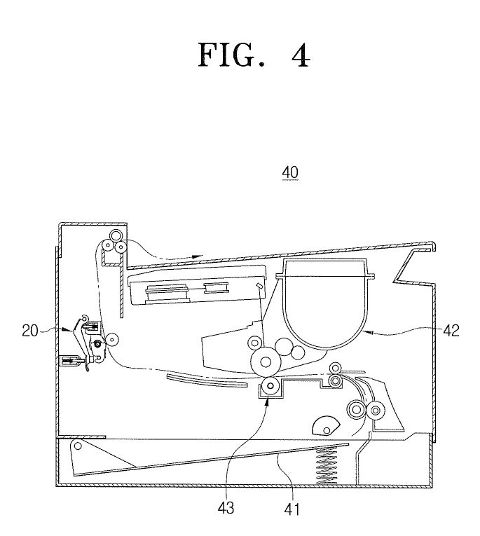

FIG. 4 illustrates an image forming apparatus including a fusing device according to aspects of the present invention. The image forming apparatus 40 of FIG. 4 includes a document feed device 41 which picks up the document from the paper tray and feeds the document along a predetermined feed path, a developing device 42 which applies developing materials to an electrostatic latent image and develops the image, a transfer device 43 which transfers the developed image onto the document, and a fusing apparatus 20, as described above. It is understood that the fusing device according to aspects of the present invention may be used with various types of image forming apparatuses other than the type shown in FIG. 4, including, for example, ink jet printers. Additionally, it is understood that the image forming apparatus is not required to have an S-type feed path, and may instead have other types of feed paths, such as a C-type feed path, as well as other components instead of or in addition to those components shown in FIG. 4 and described above.

The fusing device of the image forming apparatus according to aspects of the present invention provides a two-ended lever, so the user can open the cover of the image forming apparatus with little effort and release the pressure from the fusing device, and provides a fusing device of an image forming apparatus which adds pressure to the fusing device in a stable fashion when the cover is closed.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A fusing device of an image forming apparatus, comprising:
a fusing unit having a heating roller and a pressure roller which contact each other and rotate together;
a cover which opens and closes the fusing unit; and
a pressure and release unit, comprising:
a rotational shaft, and
a member rotatable about the rotational shaft and having a pressuring part that transmits pressure to the pressure roller in a direction of the heating roller if the cover is shut and a pressured part pressured by the cover and disposed farther than the pressuring part from the rotational shaft.

2. The fusing device of claim 1, wherein the cover comprises a pressure boss to transmit the pressure to the pressured part.

3. The fusing device of claim 2, wherein the pressure and release unit further comprises:
a second rotational shaft; and
a second member rotatable about the rotational shaft and having a second pressure boss pressured by the pressuring part and a second pressuring part that is closer than the second pressure boss to the second rotational shaft and transmits the pressure to the pressure roller.

4. The fusing device of claim 3, wherein the second pressure boss is attached to the second pressuring part.

5. The fusing device of claim 4, wherein the pressure boss comprises:
a spring disposed inside of the pressure boss; and
a sliding component attached to the spring and which protrudes outside of the pressure boss and contacts the pressured part.

6. The fusing device of claim 5, wherein the second pressure boss comprises:
a second spring disposed inside of the second pressure boss; and
a second sliding component attached to the second spring and which protrudes outside of the second pressure boss and is pressed by the pressuring part.

7. The fusing device of claim 6, wherein a stiffness of the second spring is greater than a stiffness of the spring.

8. The fusing device of claim 3, wherein the second pressuring part is a side of a recess in which a rotational shaft of the pressure roller is rotatably inserted and which presses the pressure roller in a direction of the heating roller when the cover is closed.

9. The fusing device of claim 1, comprising a stopper to limit a rotation of the member to a predetermined internal range.

10. The fusing device of claim 1, wherein a ratio between a length from the rotational shaft to the pressuring part and a length from the rotational shaft to the pressured part is approximately 11:73.5.

11. The fusing device of claim 3, wherein a ratio between a length from the second rotational shaft to the second pressuring part and a length from the second rotational shaft to the second pressure boss is approximately 23:55.

12. An image forming apparatus comprising:
a document feed device which picks up a document from a feeding tray and feeds the document along a feed path;
a developing device which applies developing materials to an electrostatic latent image to develop the electrostatic latent image;
a transfer device which transfers the developing materials onto the document; and
a pressure and release unit, comprising:
a fixing unit having a heating roller and a pressure roller which contact each other and rotate together,
a cover which opens and closes the fixing unit,
a rotating shaft, and
a member, one side of which is rotatably fixed to the rotating shaft, the member comprising:
a pressuring part which transmits pressure to the pressure roller when the cover is shut; and
a pressured part disposed at a position farther than the pressuring part from the rotating shaft and which is pressured by the cover when the cover is shut.

13. The image forming apparatus of claim 12, wherein the cover comprises a pressure boss to transmit the pressure to the pressured part.

14. The image forming apparatus of claim 13, wherein the pressure and release unit further comprises:
a second rotating shaft; and
a second member, one side of which is rotatably fixed to the second rotating shaft, comprising:
a second pressure boss pressured by the pressuring part, and
a second pressuring part which is disposed closer than the second pressure boss to the second rotating shaft, and which transmits the pressure to the pressure roller.

15. The image forming apparatus of claim 14, wherein the second pressure boss is attached to the second pressuring part.

16. The image forming apparatus of claim 15, wherein the pressure boss comprises:
a spring disposed inside of the pressure boss; and
a sliding component attached to the spring and which protrudes outside of the pressure boss and contacts the pressured part.

17. The image forming apparatus of claim 16, wherein the second pressure boss comprises:
a second spring disposed inside of the second pressure boss; and
a second sliding component attached to the second spring and which protrudes outside of the second pressure boss and is pressed by the pressuring part.

18. The image forming apparatus of claim 17, wherein a stiffness of the second spring inside the second pressure boss is greater than a stiffness of the spring inside the pressure boss.

19. The image forming apparatus of claim 14, wherein the second pressuring part is a side of a recess in which a rotational shaft of the pressure roller is rotatably inserted and which presses the pressure roller in a direction of the heating roller when the cover is closed.

20. The image forming apparatus of claim 12, comprising a stopper to limit a rotation of the member to a predetermined internal range.

21. The image forming apparatus of claim 12, wherein a ratio between a length from the rotational shaft to the pressuring part and a length from the rotational shaft to the pressured part is approximately 11:73.5.

22. The image forming apparatus of claim 14, wherein a ratio between a length from the second rotational shaft to the second pressuring part and a length from the second rotational shaft to the second pressure boss is approximately 23:55.

23. A fusing device of an image forming apparatus, comprising:
a fusing unit having a heating roller and a pressure roller which contact each other and rotate together;
a cover to access the fusing unit, which is pushed closed when pressure is applied thereto; and
a lever unit disposed between the fusing unit and the cover, comprising:
a first rotational shaft,
a first lever rotatably attached at one end to the first rotational shaft and having a first pressured part which receives the pressure from the cover and a first pressuring part which transmits and amplifies the pressure by moving a shorter rotational distance than a rotational distance moved by the pressured part,
a second rotational shaft, and
a second lever rotatably attached at one end to the second rotational shaft and having a second pressured part which receives the amplified pressure from the first pressuring end and a second pressuring part which transmits and re-amplifies the amplified pressure to the pressure roller in a direction towards the heating roller by moving a shorter rotational distance than a rotational distance moved by the second pressured part.

24. The fusing device of claim 23, wherein the cover comprises a pressure boss to transmit the pressure applied to the cover to the first pressured part.

25. The fusing device of claim 24, wherein the pressure boss comprises:
a spring disposed inside of the pressure boss; and
a sliding component attached to the spring and which protrudes outside of the pressure boss and contacts the first pressured part.

26. The fusing device of claim 25, wherein the second pressured part comprises a second pressure boss, comprising:
a second spring disposed inside of the second pressure boss; and
a second sliding component attached to the second spring and which protrudes outside of the second pressure boss and is pressed by the first pressuring part.

27. The fusing device of claim 26, wherein a stiffness of the second spring is greater than a stiffness of the first spring.

28. The fusing device of claim 23, wherein the second pressuring part is a side of a recess in which a rotational shaft of the pressure roller is rotatably inserted and which presses the pressure roller in a direction of the heating roller when the cover is closed.

29. The fusing device of claim 23, comprising a stopper to limit a rotation of the first lever to a predetermined internal range.

30. The fusing device of claim 23, wherein a ratio between a length from the first rotational shaft to the first pressuring part and a length from the first rotational shaft to the first pressured part is approximately 11:73.5.

31. The fusing device of claim 23, wherein a ratio between a length from the second rotational shaft to the second pressuring part and a length from the second rotational shaft to the second pressured part is approximately 23:55.

32. An image forming apparatus, comprising:
a document feed device which picks up a document from a feeding tray and feeds the document along a feed path;
a developing device which applies developing materials to an electrostatic latent image to develop the electrostatic latent image;
a transfer device which transfers the developing materials onto the document; and
a fusing device, comprising:
a fusing unit having a heating roller and a pressure roller which contact each other and rotate together,
a cover to access the fusing unit, which is pushed closed when pressure is applied thereto, and
a lever unit disposed between the fusing unit and the cover, comprising:
a first rotational shaft;
a first lever rotatably attached at one end to the first rotational shaft and having a first pressured part which receives the pressure from the cover and a first pressuring part which transmits and amplifies the pressure by moving a shorter rotational distance than a rotational distance moved by the pressured part;
a second rotational shaft; and
a second lever rotatably attached at one end to the second rotational shaft and having a second pressured part which receives the amplified pressure from the first pressuring part and a second pressuring part which transmits and re-amplifies the amplified pressure to the pressure roller by moving a shorter rotational distance than a rotational distance moved by the second pressured part.

33. A fusing device of an image forming apparatus, comprising:
a fusing unit having a heating roller and a pressure roller which contact each other and rotate together;
a cover to access the fusing unit, which is pushed closed when pressure is applied thereto; and
a lever unit disposed between the fusing unit and the cover, comprising:
a first lever having an end rotatable about a first axis and which contacts the cover, and
a second lever having an end rotatable about a second axis and which contacts the first lever and the pressure roller,
wherein the first and second levers transmit and amplify the pressure from the cover to the pressure roller to press the pressure roller towards the heating roller.

34. The fusing device of claim 33, wherein the cover comprises a pressure boss to transmit the pressure to the first lever at a point where the first lever contacts the cover.

35. The fusing device of claim 34, wherein the pressure boss comprises:
a spring disposed inside of the pressure boss; and
a sliding component attached to the spring and which protrudes outside of the pressure boss.

36. The fusing device of claim 35, wherein the second lever comprises a second pressure boss to transmit the pressure from the first lever at a point where the second lever contacts the first lever.

37. The fusing device of claim 36, wherein the second pressure boss comprises:
a second spring disposed inside of the second pressure boss; and
a second sliding component attached to the second spring and which protrudes outside of the second pressure boss.

38. The fusing device of claim 37, wherein a stiffness of the second spring is greater than a stiffness of the first spring.

39. The fusing device of claim 33, wherein a distance between the end of the first lever and a point at which the first lever contacts the cover is greater than a distance between the end of the first lever and a point at which the second lever contacts the first lever.

40. The fusing device of claim 39, wherein a ratio of the distance between the end of the first lever and the point at which the first lever contacts the cover and the distance between the end of the first lever and the point at which the second lever contacts the first lever is approximately 11:73.5.

41. The fusing device of claim 33, wherein a distance between the end of the second lever and a point at which the second lever contacts the first lever is greater than a distance between the end of the second lever and a point at which the second lever contacts the pressure roller.

42. The fusing device of claim 41, wherein a ratio of the distance between the end of the second lever and the point at which the second lever contacts the first lever and the distance between the second lever and the point at which the second lever contacts the pressure roller is approximately 23:55.

43. An image forming apparatus, comprising:
a document feed device which picks up a document from a feeding tray and feeds the document along a feed path;
a developing device which applies developing materials to an electrostatic latent image to develop the electrostatic latent image;
a transfer device which transfers the developing materials onto the document; and
a fusing device, comprising:
a fusing unit having a heating roller and a pressure roller which contact each other and rotate together,
a cover to access the fusing unit, which is pushed closed when pressure is applied thereto, and
a lever unit disposed between the fusing unit and the cover, comprising:
a first lever having an end rotatable about a first axis and which contacts the cover; and
a second lever having an end rotatable about a second axis and which contacts the first lever and the pressure roller,
wherein the first and second levers transmit and amplify the pressure from the cover to the pressure roller to press the pressure roller towards the heating roller.
